(19) United States
(12) Patent Application Publication
(10) Pub. No.: US 2014/0004383 A1
(43) Pub. Date: Jan. 2, 2014

(54) CURRENT-PERPENDICULAR-TO-PLANE (CPP) READ SENSOR WITH Co-Fe BUFFER LAYERS

(71) Applicant: HGST Netherlands B.V., Amsterdam (NL)

(72) Inventor: Tsann Lin, Saratoga, CA (US)

(73) Assignee: HGST Netherlands B.V., Amsterdam (NL)

(21) Appl. No.: 14/015,788

(22) Filed: Aug. 30, 2013

Related U.S. Application Data
(62) Division of application No. 12/748,165, filed on Mar. 26, 2010, now abandoned.

(51) Int. Cl. G11B 5/127

(52) U.S. Cl. CPC G11B 5/1278
USPC 428/811.2

(57) ABSTRACT

A current-perpendicular-to-plane (CPP) read sensor with Co—Fe buffer layers is proposed to improve pinning and magnetoresistance properties. The read sensor comprises first and second Co—Fe buffer layers in the lower and upper portions of a keeper layer structure, respectively, third and fourth Co—Fe buffer layers in the lower and upper portion of a reference layer structure, respectively, and a fifth Co—Fe buffer layer in the lower portion of a sense layer structure. The first buffer layer is adjacent to a pinning layer and has a specific composition to improve unidirectional-anisotropy pinning properties. The second and third buffer layers are adjacent to an antiparallel-coupling layer and have specific compositions to improve bidirectional-anisotropy pinning properties. The fourth and fifth buffer layers are adjacent to a barrier or spacer layer and have specific compositions to improve magnetoresistance properties.

### RELATED APPLICATIONS

The present Patent Application is a Divisional Application of commonly assigned U.S. patent application Ser. No. 12/748,165, entitled, Current-Perpendicular-to-Plane (CPP) Read Sensor with Co—Fe Buffer Layers, which was filed on Mar. 26, 2010, which is incorporated herein.

### FIELD OF THE INVENTION

The invention relates to non-volatile magnetic storage devices and more particularly to a magnetic disk drive including a current-perpendicular-to-plane (CPP) tunneling magnetoresistance (TMR) or giant magnetoresistance (GMR) read sensor with Co—Fe buffer layers, that has improved pinning and magnetoresistance properties.

### BACKGROUND OF THE INVENTION

One of many extensively used non-volatile storage devices is a magnetic disk drive. The magnetic disk drive includes a rotatable magnetic disk and an assembly of write and read heads. The assembly of write and read heads is supported by a slider that is mounted on a suspension arm. The suspension arm is supported by an actuator that can swing the suspension arm to place the slider with its air bearing surface (ABS) over the surface of the magnetic disk.

When the magnetic disk rotates, an air flow generated by the rotation of the magnetic disk causes the slider to fly on a cushion of air at a very low elevation (fly height) over the magnetic disk. When the slider rides on the air, the actuator moves the suspension arm to position the assembly of the write and read heads over selected data tracks on the magnetic disk. The write and read heads read and write data on the magnetic disk. Processing circuitry connected to the assembly of the write and read heads then operates according to a computer program to implement writing and reading functions.

The write head includes a magnetic write pole and a magnetic return pole, which are magnetically connected with each other at a region away from the ABS, and are surrounded by an electrically conductive write coil. In a writing process, the electrically conductive write coil induces a magnetic flux in the write and return poles. This results in a magnetic write field that is emitted from the write pole to the magnetic disk in a direction perpendicular to the surface of the magnetic disk. The magnetic write field writes data on the magnetic disk, and then returns to the return pole so that it will not erase previously written data tracks.

The read head includes a read sensor which is electrically separated by insulation layers from longitudinal bias layers in two side regions, but electrically connected with lower and upper ferromagnetic shields. In a reading process, the read head passes over magnetic transitions of a data track on the magnetic disk, and magnetic fields emitting from the magnetic transitions modulate the resistance of the read sensor in the read head. Changes in the resistance of the read sensor are detected by a sense current passing through the read sensor, and are then converted into voltage changes that generate read signals. The resulting read signals are used to decode data encoded in the magnetic transitions of the data track.

A current-perpendicular-to-plane (CPP) tunneling magnetoresistance (TMR) or giant magnetoresistance (GMR) read sensor is typically used in the read head. The CPP TMR read sensor includes a nonmagnetic insulating barrier layer sandwiched between a ferromagnetic reference layer and a ferromagnetic sense layer, and the CPP GMR read sensor includes a nonmagnetic conducting spacer layer sandwiched between the reference and sense layers. The thickness of the barrier or spacer layer is chosen to be less than the mean free path of conduction electrons passing through the CPP TMR or GMR read sensor. The magnetization of the reference layer is pinned in a direction perpendicular to the ABS, and the magnetization of the sense layer is oriented in a direction parallel to the ABS. When passing the sense current through the CPP TMR or GMR read sensor, the conduction electrons are scattered at lower and upper interfaces of the barrier or spacer layer. When receiving magnetic fields emitting from the magnetic transitions on the magnetic disk, the magnetization of the reference layer remains pinned while that of the sense layer rotates. Scattering decreases as the magnetization of the sense layer rotates towards that of the reference layer, but increases as the magnetization of the sense layer rotates away from that of the reference layer. These scattering variations lead to changes in the resistance of the CPP TMR or GMR read sensor in proportion to the magnitudes of the magnetic fields, or to cos θ, where θ is an angle between the magnetizations of the reference and sense layers. The changes in the resistance of the CPP TMR or GMR read sensor are then detected by the sense current and converted into voltage changes that are detected and processed as playback signals.

The read sensor has been progressively miniaturized for magnetic recording at ever higher recording densities. In this miniaturized read sensor, the magnetization of the reference layer must be very rigidly pinned in order to ensure proper sensor operation, and the magneoresistance effects induced by the scattering must be maximized in order to ensure robust sensor operation.

### SUMMARY OF THE INVENTION

The invention provides a CPP TMR or GMR read sensor with Co—Fe buffer layers to improve pinning and magnetoresistance properties. The read sensor includes first and second Co—Fe buffer layers in the lower and upper portions of a keeper layer structure, respectively, third and fourth Co—Fe buffer layers in the lower and upper portions of a reference layer structure, respectively.

The sensor can also include a fifth Co—Fe buffer layer in the lower portion of a sense layer structure. The first buffer layer is adjacent to a pinning layer and has a specific composition to improve unidirectional-anisotropy pinning properties. The second and third buffer layers are adjacent to an antiparallel-coupling layer and have specific compositions to improve bidirectional-anisotropy pinning properties. The fourth and fifth buffer layers can be adjacent to a barrier or spacer layer and can have specific compositions to improve magnetoresistance properties. The first, second and third buffer layers only need to be as thin as 0.4 nm to improve pinning properties, and the fourth and fifth buffer layers as thin as 0.3 nm to improve magnetoresistance properties. Additional keeper, reference and sense layers may thus be used to further improve magnetoresistance properties.

These and other features and advantages of the invention will be apparent upon reading of the following detailed description of preferred embodiments taken in conjunction with the figures in which like reference numerals indicate like elements throughout.

### BRIEF DESCRIPTION OF THE DRAWINGS

For a fuller understanding of the nature and advantages of the invention, as well as the preferred mode of use, reference should be made to the following detailed description read in conjunction with the accompanying drawings which are not to scale.

FIG. 1 is a schematic illustration of a magnetic disk drive system in which the invention is embodied;

FIG. 2 is an ABS schematic view of a read head in accordance with a prior art;

FIG. 3 is an ABS schematic view of a read sensor in accordance with a prior art;

FIG. 4 is an ABS schematic view of a read sensor in accordance with a preferred embodiment of the invention;

FIG. 5 is a graph showing easy-axis responses of ferromagnetic Co—Fe films that are deposited on 6 nm thick Ir—Mn films and may be used as the first buffer layers in accordance with a preferred embodiment of the invention;

FIG. 6 is a graph showing the unidirectional anisotropy energy versus the Fe content for ferromagnetic Co—Fe films that are deposited on 6 nm thick Ir—Mn films and may be used as the first buffer layers in accordance with a preferred embodiment of the invention;

FIG. 7 is a graph showing easy-axis responses of ferromagnetic Co—Fe films that are deposited beneath and above 0.8 nm thick Ru films and may be used as second and third buffer layers in accordance with a preferred embodiment of the invention;

FIG. 8 is a graph showing the bidirectional anisotropy energy versus the Fe content for ferromagnetic Co—Fe films that are deposited beneath and above 0.8 nm thick Ru films and may be used as second and third buffer layers in accordance with a preferred embodiment of the invention;

FIG. 9 is a graph showing the TMR coefficient versus the Fe content for ferromagnetic Co—Fe films that are deposited beneath and above 0.8 nm thick MgO_{X} barrier layers and may be used as fourth and fifth buffer layers in accordance with a preferred embodiment of the invention; and

FIG. 10 is a graph showing the TMR coefficient versus the junction resistance-area product for TMR read sensors fabricated in accordance with preferred and alternative embodiments of the invention.

### DETAILED DESCRIPTION OF THE EMBODIMENTS

The following description is of the best embodiments presently contemplated for carrying out the invention. This description is made for the purpose of illustrating the general principles of the invention and is not meant to limit the inventive concepts claimed herein.

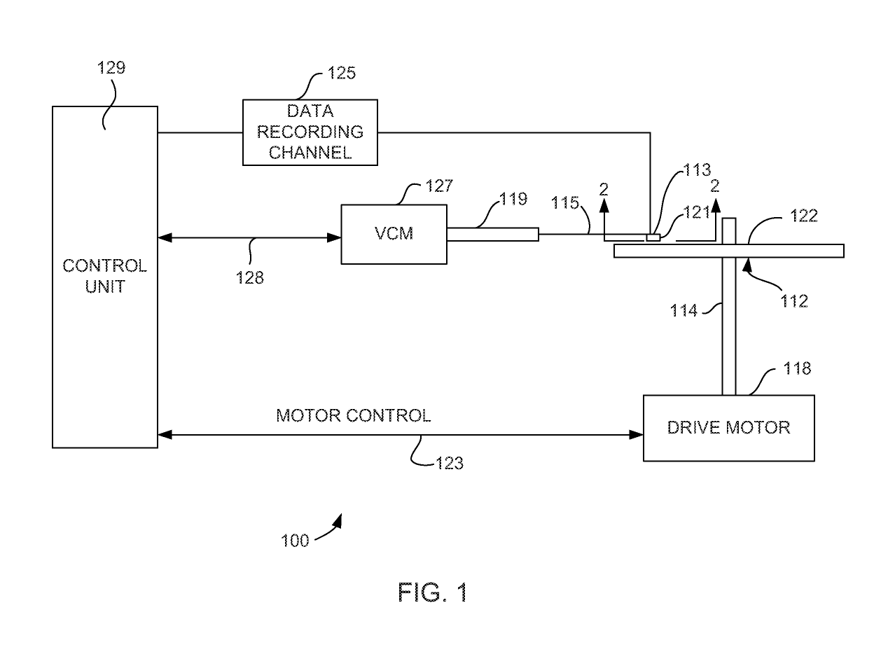

Referring now to FIG. 1, there is shown a magnetic disk drive 100 embodying the invention. As shown in FIG. 1, at least one rotatable magnetic disk 112 is supported on a spindle 114 and rotated by a disk drive motor 118. Magnetic recording on each magnetic disk is performed at annular patterns of concentric data tracks (not shown) on the magnetic disk 112.

At least one slider 113 is positioned near the magnetic disk 112, each slider 113 supporting one assembly of write and read heads 121. As the magnetic disk 112 rotates, the slider 113 moves radially in and out over the disk surface 122 so that the assembly of write and read heads 121 may access different data tracks on the magnetic disk 112. Each slider 113 is mounted on a suspension arm 115 that is supported by an actuator 119. The suspension arm 115 provides a slight spring force which biases the slider 113 against the disk surface 122. Each actuator 119 is attached to an actuator means 127 that may be a voice coil motor (VCM). The VCM comprises a coil movable within a fixed magnetic field, the direction and speed of the coil movements being controlled by the motor current signals supplied by controller 129.

During operation of the magnetic disk drive 100, the rotation of the magnetic disk 112 generates an air bearing between the slider 113 and the disk surface 122 which exerts an upward force or lift on the slider 113. The air hearing thus counter-balances the slight spring force of the suspension arm 115 and supports the slider 113 off and slightly above the disk surface 122 by a small, substantially constant spacing during sensor operation.

The various components of the magnetic disk drive 100 are controlled in operation by control signals generated by the control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position the slider 113 to the desired data track on the magnetic disk 112. Write and read signals are communicated to and from the assembly of write and read heads 121 by way of the recording channel 125.

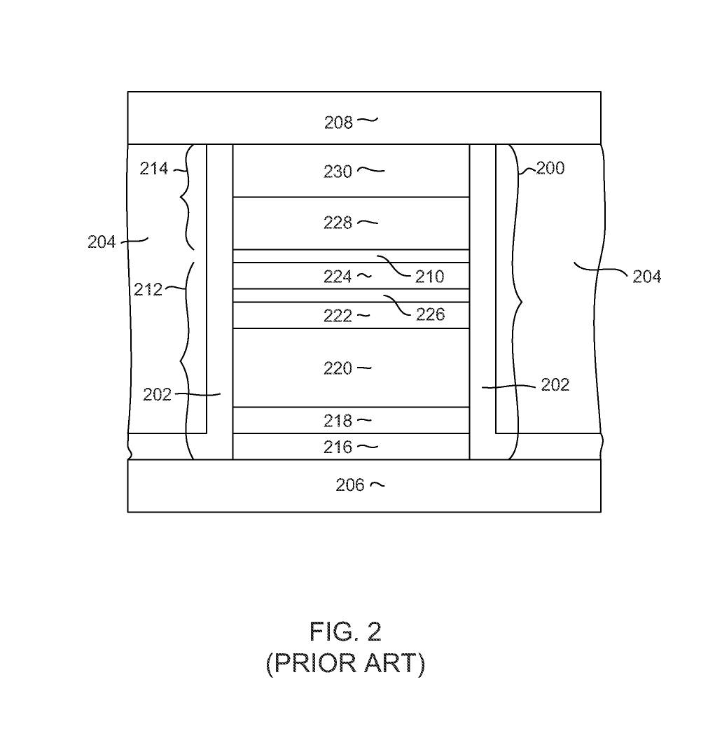

In a typical read head, as shown in FIG. 2, a current-perpendicular-to-plane (CPP) tunneling magnetoresistance (TMR) or giant magnetoresistance (GMR) read sensor 200 is electrically separated by electrical insulation layers 202 from longitudinal bias layers 204 in two side regions for preventing a sense current from shunting into the two side regions, but is electrically connected with lower and upper ferromagnetic shields 206, 208 to allow the sense current to flow in a direction perpendicular to the sensor plane. In a typical CPP TMR read sensor 200, an electrically insulating barrier layer 210 is sandwiched between lower and upper sensor stacks 212, 214. The barrier layer 210 is formed of a nonmagnetic oxygen-doped Mg (Mg—O) or Mg oxide (MgO) film having a thickness ranging from 0.4 to 1 nm. When the sense current quantum-jumps across the Mg—O or MgO barrier layer, changes in the resistance of the CPP TMR read sensor is detected through a TMR effect. In a typical CPP GMR read sensor 200, an electrically conducting spacer layer 210 is sandwiched between the lower and upper sensor stacks 212, 214. The spacer layer 210 is formed of a nonmagnetic Cu or oxygen-doped Cu (Cu—O) film having a thickness ranging from 1.6 to 4 nm. When the sense current flows across the Cu or Cu—O spacer layer, changes in the resistance of the CPP GMR read sensor 200 are detected through a GMR effect.

The lower sensor stack 212 comprises a lower seed layer 216, an upper seed layer 218, a pinning layer 220, a keeper layer 222, an antiparallel-coupling layer 226, and a reference layer 224. The upper sensor stack 214 comprises a sense layer 228 and a cap layer 230.

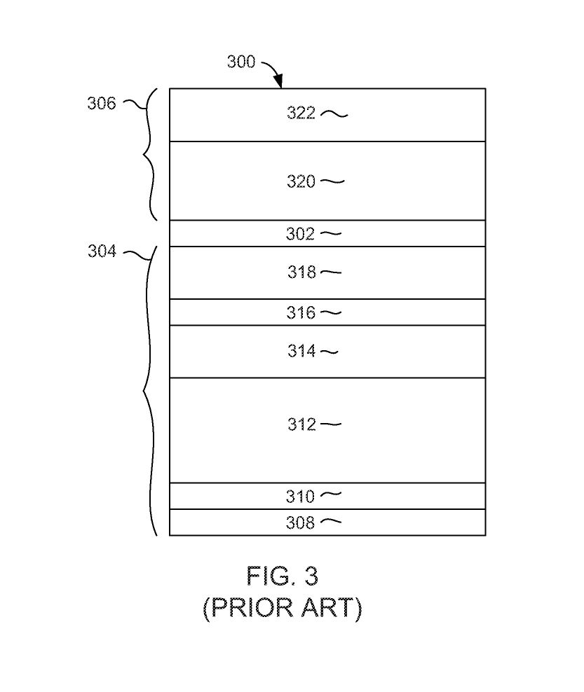

More specifically, the most extensively explored CPP TMR read sensor 300, as shown in FIG. 3, comprises an electrically insulating MgO_{X} barrier layer 302 sandwiched between lower and upper sensor stacks 304, 306. The MgO_{X} barrier layer is formed of a 0.2 nm thick oxygen-doped Mg (Mg—O) film, a 0.4 nm thick MgO film, and another 0.2 nm thick oxygen-doped Mg (Mg—O) film.

The lower sensor stack 304 typically comprises a lower seed layer 308 formed of a nonmagnetic Ta film, an upper seed layer 310 formed of a nonmagnetic Ru film, a pinning layer 312 formed of an antiferromagnetic Ir—Mn film, a keeper layer 314 formed of a ferromagnetic Co—Fe film, an antiparallel-coupling layer 316 formed of a nonmagnetic Ru film, and a reference layer 318 formed of a ferromagnetic Co—Fe—B film. The upper sensor stack comprises a sense layer 320 formed of a ferromagnetic Co—Fe—B film and a cap layer 322 formed of a nonmagnetic Ru film.

The keeper layer 314, the antiparallel-coupling layer 316, and the reference layer 318 form a flux-closure structure where four fields are induced. First, a unidirectional anisotropy field (H_{UA}) is induced by exchange coupling between the pinning and keeper layers 312, 314, Second, a bidirectional anisotropy field (H_{BA}) is induced by antiparallel coupling between the keeper and reference layers 314, 318 and across the antiparallel-coupling layer 316. Third, a demagnetizing field (H_{D}) is induced by the net magnetization of the keeper and reference layers 314, 318. Fourth, a ferromagnetic-coupling field (H_{F}) is induced by ferromagnetic coupling between the reference and sense layers 318, 320 and across the barrier layer 302. To ensure proper sensor operation, H_{UA} and H_{BA} must be high enough to rigidly pin magnetizations of the keeper and reference layers 314, 318 in opposite transverse directions perpendicular to an air bearing surface (ABS), while H_{D} and H_{F} must be small and balance with each other to orient the magnetization of the sense layer 320 in a longitudinal direction parallel to the ABS.

When a sense current flows in a direction perpendicular to interfaces of the layers of the TMR read sensor 300, the TMR read sensor acts as a series circuit where the sense current flows through various metallic films 308, 310, 312, 314, 316, 318, 320, 322 with electrical resistivities of less than 200 μΩ-cm and through the MgO_{X} barrier layer 302 with an electrical resistivity of more than 1×10⁵ μΩ-cm. The highest-resistance path in the series circuit, which can be characterized by a product of junction resistance and area (R_{J}A_{J}) thus depends on the electrical resistivity of the MgO_{X} barrier layer 302 and contact resistances at lower and upper interfaces of the MgO_{X} barrier layer 302. When the sense current quantum-jumps across the MgO_{X} barrier layer 320 and a magnetic field aligns the magnetization of the sense layers from the same direction as that of the reference layer to an opposite direction, its resistance increases by ΔR_{T} due to a TMR effect. The strength of this TMR effect, which can be characterized by a TMR coefficient (ΔR_{T}/R_{J}), mainly depends on coherent scattering of conduction electrons at the lower and upper interfaces of the MgO_{X} barrier layer 320.

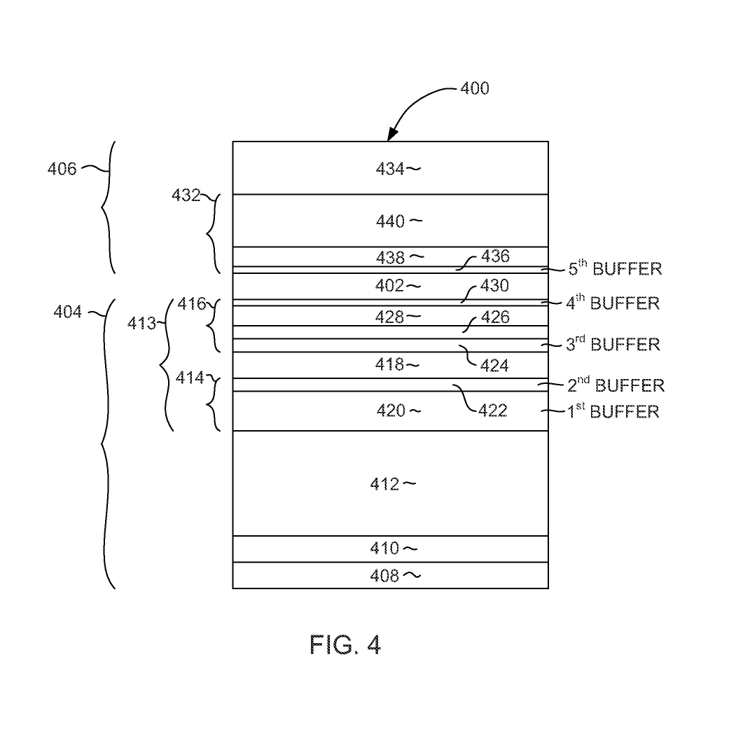

FIG. 4 shows an ABS view of a CPP TMR read sensor 400 in accordance with a preferred embodiment of the invention. In the TMR read sensor 400, an electrically insulating MgO_{X} barrier layer 402 is sandwiched between lower and upper sensor stacks 404, 406. The MgO_{X} barrier layer 402 is formed of a 0.2 nm thick oxygen-doped Mg (Mg—O) film, a 0.4 nm thick MgO film, and another 0.2 nm thick oxygen-doped Mg (MgO) film.

The lower sensor stack 404 comprises a lower seed layer 408 formed of a 2 nm thick nonmagnetic Ta film, an upper seed layer 410 formed of a 2 nm thick nonmagnetic Ru film, a pinning layer 412 formed of a 6 nm thick antiferromagnetic 23.2Ir-76.8Mn film (composition in atomic percent), and a flux-closure structure 413.

In the flux-closure structure 413, an antiparallel-coupling layer 418 formed of a 0.8 nm thick nonmagnetic Ru film is sandwiched between a keeper layer structure 414 and a reference layer structure 416. The keeper layer structure 414 is adjacent to and exchange-couples with the pinning layer 412, so that the magnetization of the keeper layer structure 414 is pinned in a transverse direction perpendicular to and away from the ABS. The reference layer structure 416 is adjacent to the antiparallel-coupling layer 418 and antiparallel-couples with the keeper layer structure 414, so that the magnetization of the reference layer structure 416 is pinned in another transverse direction perpendicular to but towards the ABS (or opposite to that of the reference layer structure 414).

The keeper layer structure 414 comprises a first buffer layer 420 formed of a 1.6 nm thick ferromagnetic 72.5Co-27.5Fe film, an intermediate keeper layer formed of a ferromagnetic Co—Fe, Co—Hf or Co—Fe—B film, and a second buffer layer 422 formed of a 0.6 nm thick ferromagnetic 64.1Co-35.9Fe film. It should be noted that the intermediate keeper layer is not shown in FIG. 4 since both the first buffer and intermediate keeper layers are formed of an identical ferromagnetic Co—Fe film. Both the first and second buffer layers 420, 422 only need to be as thin as 0.4 nm thick to attain high H_{UA} and H_{BA}, but may be thick enough to replace the intermediate keeper layer and for the keeper layer structure 414 to exhibit a magnetic moment of 0.32 memu/cm² (corresponding to that of a 4.6 nm thick ferromagnetic 80Ni-20Fe films sandwiched into two Cu films).

The reference layer structure 416 comprises a third buffer layer 424 formed of a 0.6 nm thick ferromagnetic 64.1Co-35.9 Fe film, a first intermediate reference layer 426 formed of a 0.6 nm thick ferromagnetic 75.5Co-24.5Hf film, a second intermediate reference layer 428 formed of a 1.2 nm thick ferromagnetic 65.5Co-19.9Fe-14.6B film, and the fourth buffer layer 430 formed of a 0.3 nm thick ferromagnetic 46.8Co-53.2Fe film. It should be noted that the first intermediate reference layer 426 of at least 0.4 nm in thickness must be used to prevent the B diffusion through the second intermediate reference layer 428, and the second intermediate reference layer 428 of at least 0.8 nm in thickness must be used to attain high ΔR_{T}/R_{J}. On the other hand, the third buffer layer 424 can be as thin as 0.4 nm thick to attain high H_{BA}, while the fourth buffer layer 430 can be as thin as 0.3 nm thick to attain high ΔR_{T}/R_{J}. Therefore, the third and buffer layers 424, 430 are preferably thin, while the first and second intermediate reference layers 426, 428 are preferably thick enough for the reference layer structure 416 to exhibit a magnetic moment of 0.30 memu/cm² (corresponding to that of a 4.3 nm thick ferromagnetic 80Ni-20Fe films sandwiched into two Cu films).

The upper sensor stack 406 comprises a sense layer structure 432 and a cap layer 434 formed of a 6 nm thick nonmagnetic Ru film. The sense layer structure 432 comprises a fifth buffer layer 436 formed of a 0.4 nm thick ferromagnetic 46.8Co-53.2Fe film, an intermediate sense layer 438 formed of a 1.6 nm thick ferromagnetic 79.3Co-4.0Fe-16.7B film, and an upper sense layer 440 formed of a 2.8 nm thick ferromagnetic 87.1Co-12.9Hf film. It should be noted that the intermediate sense layer 438 of at least 1.2 nm in thickness must be used to attain high ΔR_{T}/R_{J}, and the upper sense layer 440 of at least 0.8 nm in thickness must be used in the intermediate sense layer 438 to prevent boron diffusion, thus attaining higher ΔR_{T}/R_{J} at lower R_{J}A_{J}. Therefore, the fifth buffer layer 436 can be thicker than needed (0.3 nm) for the sense layer structure 432 to attain a magnetic moment of 0.42 memu/cm² (corresponding to that of a 6.0 nm thick ferromagnetic 80Ni-20Fe films sandwiched into two Cu films), and to attain even higher ΔR_{T}/R_{J}. However, a slight increase in the thickness of the fifth buffer layer 436 will cause a substantial increase in the saturation magnetostriction (λ_{S}) of the sense layer structure 432 due to its high Fe content. As a result, the fifth buffer layer 436 is preferably as thin as 0.4 nm thick, while the intermediate and upper sense layers 438, 440 are preferably as thick as 1.6 and 2.8 nm thick, respectively, in order to attain a low λ_{S}.

In the preferred embodiment of the invention, the first 72.5Co-27.5Fe buffer layer 420 is used in the lower portion of the keeper layer structure 414 in order to attain high H_{UA}, while the second and third 64.1Co-35.9Fe buffer layers 422, 424 are used in the upper portion of the keeper layer structure 414 and in the lower portion of the reference layer structure 416, respectively, in order to attain high H_{BA}. Such high H_{UA} and H_{BA} will allow the CPP TMR read sensor to exhibit high pinning properties and proper operation. In addition, the fourth and fifth 46.8Co-53.2Fe buffer layers 430, 436 are used in the upper portion of the reference layer structure 416 and in the lower portion of the sense layer structure 432, respectively, in order to attain high ΔR_{T}/R_{J} at low R_{J}A_{J}. Such high ΔR_{T}/R_{J} at low R_{J}A_{J} will allow the CPP TMR read sensor to exhibit high magnetoresistance properties and robust operation.

Alternatively, the first Co—Fe buffer layer 420 may contain an Fe content ranging from 24 to 32 at % and have a thickness of more than 0.4 nm, in order to attain high H_{UA}. The second and third Co—Fe buffer layers 422, 424 may contain an Fe content ranging from 32 to 40 at % and have thicknesses of more than 0.4 nm, in order to attain high H_{BA}. The first Co—Fe buffer layer 420, the second Co—Fe buffer layer 422, the Ru antiparallel-coupling spacer layer 418, and the third Co—Fe buffer layer 424 are preferably deposited sequentially in one module of a sputtering system, in order to ensure interface cleanness, thus maximizing H_{UA} and H_{BA}.

The fourth and fifth Co—Fe butler layers 430, 436 may contain an Fe content ranging from 40 to 80 and have thicknesses of more than 0.3 nm, in order to decrease R_{J}A_{J} through suppression of boron diffusion and segregation at interfaces of the MgO_{X} barrier layer 402 during annealing, and increase ΔR_{T}/R_{J} through the enhancement of coherent spin polarization across the MgO_{X} barrier layer 402. The fourth Co—Fe buffer layer 430, the MgO_{X} barrier layer 402, and the fifth Co—Fe buffer layer 436 are preferably deposited sequentially in one module of a sputtering system, in order to ensure interface cleanness, thus minimizing R_{J}A_{J} while maximizing ΔR_{T}/R_{J}.

The TMR read sensor 400 in accordance with the preferred embodiment of the invention is deposited on a bare glass substrate (not shown) and on a wafer with a lower shield 206 formed by a 1 μm thick ferromagnetic Ni—Fe film (FIG. 2) in various modules of a sputtering system (not shown). The Ta(2)/Ru(2)/23.2Ir-76.8Mn(6) films 408, 410, 412 are preferably deposited in the first module, and the 72.5Co-27.5Fe(1.6)/64.1Co-35.9Fe(0.6)/Ru(0.8)/64.1 Co-35.9Fe(0.6)/75.5Co-24.5Hf(0.6) /65.5Co-19.9Fe-14.6B(1.2)/46.8Co-53.2 Fe(0.4) films 420, 422, 418, 424, 426, 428, 430 are sequentially deposited in the second module. After applying a plasma treatment for 72 seconds at a substrate power of 20 W to remove about 0.1 nm of the 46.8Co-53.2Fe film 430 and to smoothen the surface of the lower sensor stack 404, the MgO_{X} harrier layer 402 is formed in the third module, as described below.

After slightly cleaning a Mg target, a 0.2 nm thick Mg film is DC-deposited from the Mg target, and a light oxygen treatment is then applied for oxygen doping into the Mg film. After heavily cleaning the third module with Ta gettering and slightly cleaning a MgO target, a 0.4 nm thick MgO film is RF-deposited from the MgO target, another 0.2 nm thick Mg film is DC-deposited from the Mg target, and then a heavy oxygen treatment is applied for oxygen doping into the entire barrier layer 402, After the formation of the MgO_{X} barrier layer 402, the 46.8Co-53.2Fe(0.4)/79.3Co-4.0Fe-16.7B(1.6)/87.1Co-12.9Hf(2.8)/Ru(2)/Ta(2)/Ru(4) films 436, 438, 440, 434 are preferably deposited in the fourth module of the sputtering system.

After annealing in a magnetic field of 50,000 Oe for 5 hours at 280° C. in a high-vacuum oven, the TMR read sensor 400 deposited on the bare glass substrate is measured with a vibrating sample magnetometer to determine H_{UA} and H_{BA}. The TMR read sensor 400 deposited on the wafer with the lower shield 206 (FIG. 2) is coated with Cu(75)/Ru(12) top conducting leads (not shown), and is probed with a 12-point microprobe in a magnetic field of about 160 Oe. Measured data from any four of the microprobe are analyzed with a current-in-plane tunneling model to determine R_{J}A_{J} and ΔR_{T}/R_{J}.

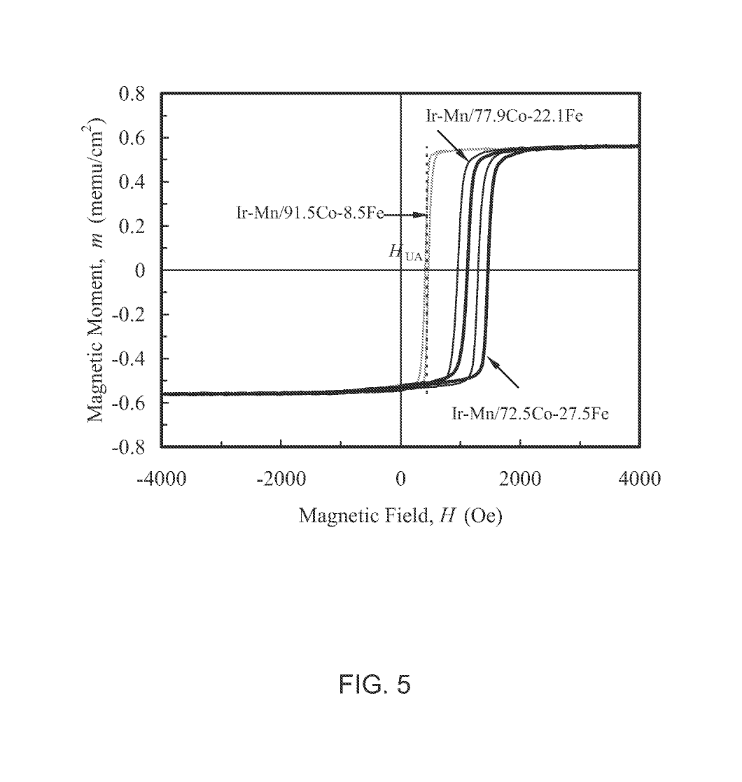

FIG. 5 shows easy-axis responses of Ta(2)/Ru(2)/23.21r-76.8Mn(6)/Co—Fe(˜3.6)/Ru(6)/Ta(4)/Ru(4) films (thickness in nm) after annealing for 5 hours at 280° C. The thickness of the Co—Fe film is adjusted around 3.6 nm in order to attain a magnetic moment (m) of 0.56 memu/cm². H_{UA} is determined from the shift of a hysteresis loop from an original point, while an intrinsic unidirectional anisotropy energy (J_{UA}) is calculated from J_{UA}=mH_{UA}. As shown in FIG. 5, for Fe contents of 8.5, 22.1 and 27.5 at %, H_{UA} values reach 438, 1,126 and 1,288 Oe, respectively (corresponding to J_{UA} of 0.24, 0.63 and 0.72 erg/cm², respectively). Hence, when replacing the conventionally used 77.9Co-22.1 Fe film with the 72.5Co-27.5 Fe film as the first buffer layer 420 in contact with the Ir—Mn film 412 in accordance with the preferred embodiment of the invention, H_{UA} increases by 14.4%.

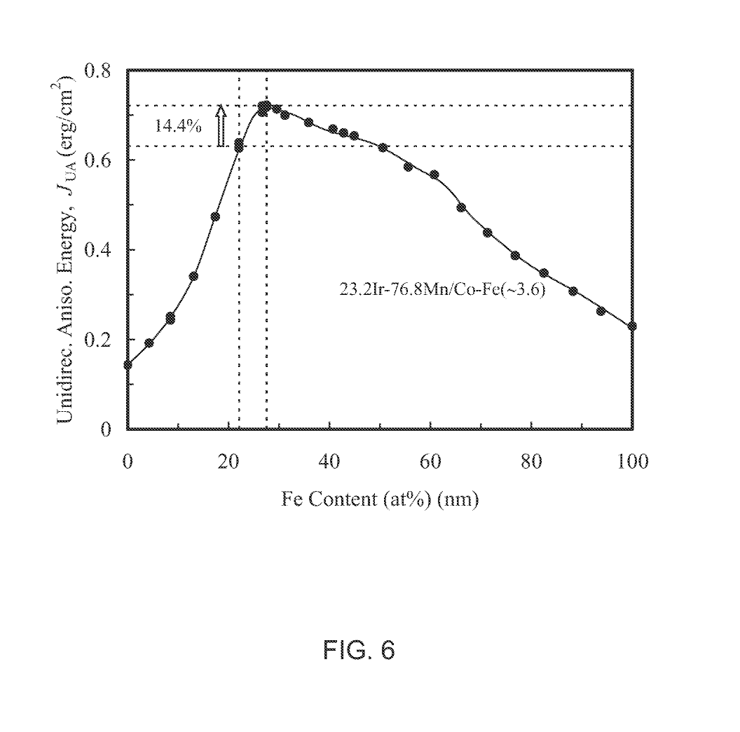

FIG. 6 shows J_{UA} versus the Fe content of the Ta(2)/Ru(2)/22.51r-77.5Mn(6)/Co—Fe(˜3.6)/Ru(6)/Ta(4)/Ru(4) films after annealing for 5 hours at 280° C. J_{UA} increases from 0.14 to 0.72 erg/cm² as the Fe content increases from 0 to 27.5 at %, and then decreases from 0.72 to 0.23 erg/cm² as the Fe content increases from 27.5 to 100 at %. FIG. 6 indicates that J_{UA} is maximized when the 72.5Co-27.5Fe film is used as the first buffer layer 420 in contact with the Ir—Mn film 412 in accordance with the preferred embodiment of the invention.

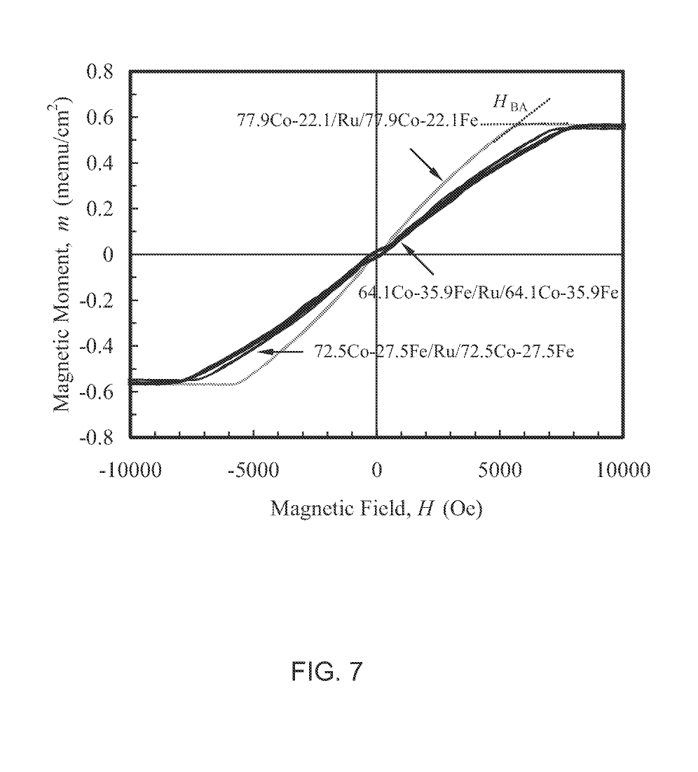

FIG. 7 shows easy-axis responses of Ta(2)/Ru(2)/Co—Fe(˜2.1)/Ru(0.8)/Co—Fe(˜2.1)/Ru(6)/Ta(4)/Ru(4) films after annealing for 5 hours at 280° C. The thickness of the Co—Fe film beneath or above the Ru antiparallel-coupling layer is adjusted around 2.1 nm in order to attain a magnetic moment (m) of 0.28 memu/cm². H_{BA} is determined from the saturation field of a hysteresis loop, while an intrinsic bidirectional anisotropy energy (J_{BA}) is calculated from J_{BA}=mH_{BA}. As shown in FIG. 7, for Fe contents of 22.1, 27.5 and 35.9 at %, H_{BA} values reach 5,662 Oe, 7,215 Oe and 7,872 Oe, respectively (corresponding to J_{BA} of 1.54, 1.91 and 2.22 erg/cm², respectively). Hence, when replacing the conventionally used 77.9Co-22.1Fe films with the 64.1Co-35.9Fe films as the second buffer layer 422 and the third buffer layer 424 in accordance with the preferred embodiment of the invention, H_{BA} increases by 43.5%.

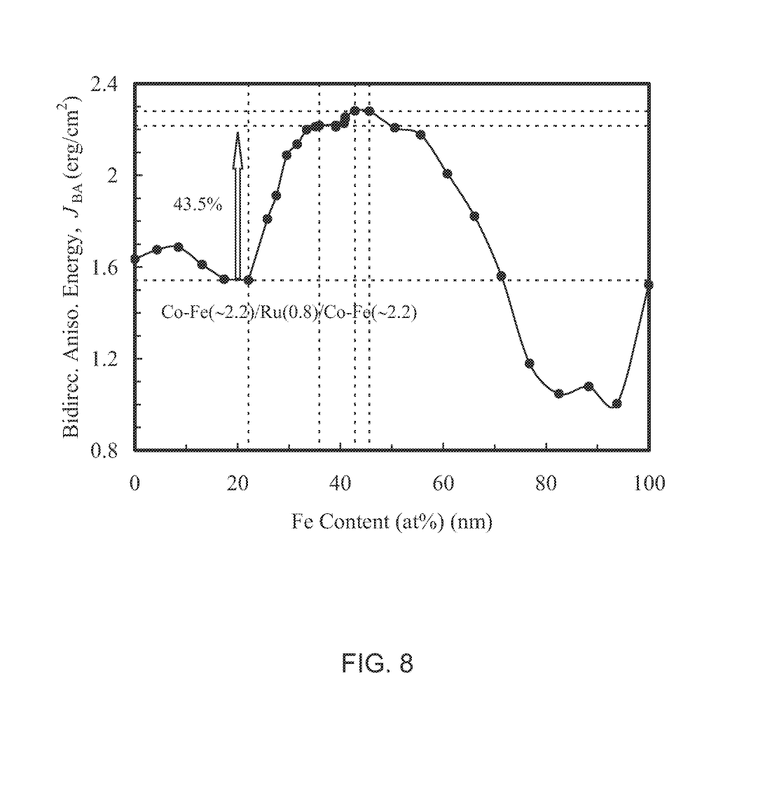

FIG. 8 shows J_{BA} versus the Fe content of the Ta(2)/Ru(2)/Co—Fe(˜2.1)/Ru(0.8)/Co—Fe(˜2.1)/Ru(6)/Ta(4)/Ru(4) films after annealing for 5 hours at 280° C. J_{BA} increases from 1.54 to 2.21 erg/cm² as the Fe content increases from 22.1 to 35.9 at %, increase to 2.28 erg/cm² as the Fe content ranges from 42.8 and 45.6 at %, and then decreases to 1.05 erg/cm² as the Fe content increases to 82.5 at %. FIG. 8 indicates that J_{BA} is maximized when the Fe content ranges from 42.8 and 45.6 at %. Since such high Fe contents lead to open hysteresis loops, indicating possible Fe diffusion and thermal degradation, the 64.1Co-35.9Fe films are suggested to be used as the second and third buffer layers 422, 424.

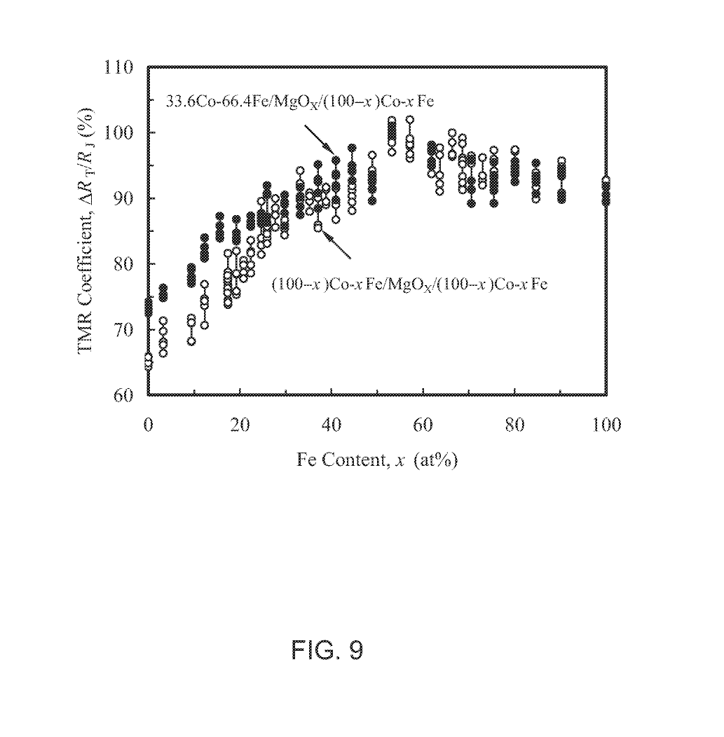

FIG. 9 shows ΔR_{T}/R_{J} versus the Fe content for TMR read sensors comprising Ta(2)/Ru(2)/22.5Ir-77.5Mn(6)/22.5Co-27.5Fe(1.6)/64.1Co-35.9Fe(0.6)/Ru(0.8)/64.1Co-35.9Fe(0.6)/75.5Co-24.5Hf(0.6)/65.5Co-19.9Fe-14.6B(1.2)/fourth buffer layer/MgO_{X}(0.8)/(100−x)Co-xFe(˜0.4)/79.3Co-4.0Fe-16.7B(1.6)/87.1Co-12.9Hf(2.8)/Ru(2)/Ta(2)/Ru(4) films, where the fourth buffer layer 430 is formed of a (100−x)Co-xFe(˜0.4) or 33.6Co-66.4F(0.4) film. The thicknesses of the (100−x)Co-xFe fourth buffer layer 430 is adjusted around 0.4 nm in order for the reference layer structure 416 to attain a magnetic moment of 0.30 memu/cm² (corresponding to that of a 4.3 nm thick ferromagnetic 80Ni-20Fe film sandwiched into two Cu films). The thicknesses of the (100−x)Co-xFe fifth buffer layer 436 is adjusted around 0.4 nm in order for the sense layer structure 432 to attain a magnetic moment of 0.42 memu/cm² (corresponding to that of a 6.0 nm thick ferromagnetic 80Ni-20Fe film sandwiched into two Cu films).

In the symmetrical case where both the fourth and fifth buffer layers 430, 436 are formed of Co—Fe films with correspondingly varying Fe contents, ΔR_{T}/R_{J} increases from 65.0 to 100.7% as the Fe content increases from 0 to 53.2 at %, and then decreases to 92.3% as the Fe content increases 100 at %. In the asymmetrical case where the fourth buffer layer 430 is formed of the 33.6Co-66.4Fe film while the fifth buffer 436 layer is formed of the Co—Fe film with varying Fe contents, ΔR_{T}/R_{J} increases from 73.5 to 100.2% as the Fe content increases from 0 to 53.2 at %, and then decreases to 90.4% as the Fe content increases 100 at %. FIG. 9 suggests that both the fourth and fifth buffer layers 430, 436 are preferably formed of Co—Fe films with Fe contents ranging from 40 to 80 at % and with thicknesses of around 0.4 nm, in order to attain R_{J}A_{J} of as low as around 1 Ω-μm² through suppression of boron diffusion and segregation at interfaces of the MgO_{X} barrier layer 402 during annealing, and attain ΔR_{T}/R_{J} of more than 95% through the enhancement of coherent spin polarization across the MgO_{X} barrier layer 402.

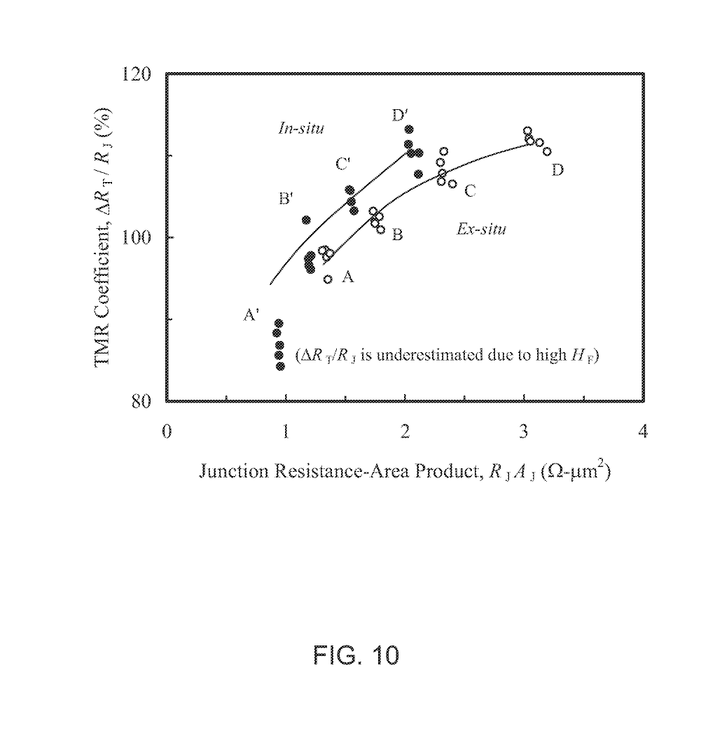

In an alternative method of fabricating the TMR read sensor 400, the 46.8Co-53.2Fe fourth buffer layer 430, the MgO_{X} barrier layer 402 and the 46.8Co-53.2Fe fifth buffer layer 436 are sequentially deposited in the third module of the sputtering system. FIG. 10 shows R_{J}A_{J} versus ΔR_{T}/R_{J} for the TMR read sensor proposed in the preferred and alternative embodiments of the invention. In an ex-situ case where the fourth buffer layer 430, the MgO_{X} barrier layer 402 and the fifth buffer layer 436 are deposited in three different modules, the TMR read sensors with 0.80, 0.82, 0.84 and 0.86 nm thick MgO_{X} barrier layers 402 exhibit R_{J}A_{J} of 1.34, 1.76, 2.33 and 3.09 Ω-μm², respectively (as labeled as A, B, C and D in FIG. 10, respectively). In an in-situ case where the fourth buffer layer 430, the MgO_{X} barrier layer 402 and the fifth buffer layer 436 are deposited in the third module only, the TMR read sensors with 0.80, 0.82, 0.84 and 0.86 nm thick MgO_{X} barrier layers 402 exhibit R_{J}A_{J} of 0.94, 1.19, 1.57 and 2.07 Ω-μm², respectively (as labeled as A′, B′, C′ and D′ in FIG. 10, respectively). The lower R_{J}A_{J} in the in-situ case originates from lower contact resistance at cleaner lower and upper interfaces of the MgO_{X} barrier layer 402. On the other hand, a higher ΔR_{T}/R_{J} is expected in the in-situ case due to the enhancement of coherent scattering at the cleaner lower and upper interfaces of the MgO_{X} barrier layer 402, The higher ΔR_{T}/R_{J} is not attained when comparing four corresponding sets of data, but in fact is attained when comparing ΔR_{T}/R_{J} at the same R_{J}A_{J}.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A read sensor, comprising:
a non-magnetic barrier or spacer layer sandwiched between upper and lower sensor stacks, the upper sensor stack comprising a magnetic sense layer structure, the lower sensor stack comprising a pinning layer, a keeper layer structure formed on the pinning layer, a non-magnetic antiparallel coupling layer formed on the keeper layer and a reference layer structure formed on the non-magnetic antiparallel coupling layer, wherein:
the keeper layer structure comprises a Co—Fe buffer layer adjacent to the pinning layer, a second Co—Fe buffer layer adjacent to the non-magnetic antiparallel coupling layer and an intermediate layer comprising Co—Hf or Co—Fe—B sandwiched between the first and second Co—Fe buffer layers; and
the reference layer structure comprises:
a third Co—Fe buffer layer adjacent to the non-magnetic antiparallel coupling layer;
a first intermediate reference layer comprising a Co—Hf film formed on the third buffer layer;
a second intermediate reference layer comprising Co—Fe—B formed on the first intermediate reference layer, and
a fourth Co—Fe buffer layer formed of a ferromagnetic Co—Fe—B film formed on the second intermediate reference layer.

2. The read sensor as in claim 1, wherein the second and third buffer layers each comprise 60-68 atomic percent Co and 32 to 40 atomic percent Fe, and each have a thickness of 0.4 to 2.4 nm.

3. The read sensor as in claim 1, wherein:
the sense layer structure further comprises:
a fifth Co—Fe buffer layer adjacent to the non-magnetic barrier or spacer layer;
a layer comprising Co—Fe—B formed on the fifth Co—Fe buffer layer; and
a layer comprising Co—Hf formed on the layer of Co—Fe—Be; and
wherein the fourth and fifth Co—Fe buffer layers each comprise 20-60 atomic percent Co and 40-80 atomic percent Fe, and each have a thickness of 0.3 to 2.4 nm.

4. A read sensor, comprising:
a non-magnetic barrier or spacer layer sandwiched between upper and lower sensor stacks, the upper sensor stack comprising a magnetic sense layer structure, the lower sensor stack comprising a pinning layer, a keeper layer structure formed on the pinning layer, a non-magnetic antiparallel coupling layer formed on the keeper layer and a reference layer structure formed on the non-magnetic antiparallel coupling layer, wherein:
the reference layer structure comprises:
a first Co—Fe buffer layer adjacent to the non-magnetic antiparallel coupling layer;
a first intermediate reference layer comprising a Co—Hf film formed on the first buffer layer;
a second intermediate reference layer comprising Co—Fe—B formed on the first intermediate reference layer, and
a second Co—Fe buffer layer formed of a ferromagnetic Co—Fe—B film formed on the second intermediate reference layer.

5. The read sensor as in claim 4, wherein the first buffer layer comprises 60-68 atomic percent Co and 32 to 40 atomic percent Fe.

6. The read sensor as in claim 4, wherein the first buffer layers comprises 60-68 atomic percent Co and 32 to 40 atomic percent Fe, and has a thickness of 0.4 to 2.4 nm.

7. The read sensor as in claim 4, wherein the second Co—Fe buffer layer comprises 20-60 atomic percent Co and 40-80 atomic percent Fe.

8. The read sensor as in claim 4, wherein the second Co—Fe buffer layer comprises 20-60 atomic percent Co and 40-80 atomic percent Fe and has a thickness of 0.3-2.4 nm.

9. The read sensor as in claim 4, wherein the first buffer layer comprises 60-68 atomic percent Co and 32 to 40 atomic percent Fe, and the second Co—Fe buffer layer comprises 20-60 atomic percent Co and 40-80 atomic percent Fe.

10. The read sensor as in claim 4, wherein the first buffer layer comprises 60-68 atomic percent Co and 32 to 40 atomic percent Fe and has a thickness of 0.4 to 2.4 nm, and the second Co—Fe buffer layer comprises 20-60 atomic percent Co and 40-80 atomic percent Fe and has a thickness of 0.3 to 2.4 nm.
